(19) United States
(12) Patent Application Publication
(10) Pub. No.: US 2008/0155851 A1
(43) Pub. Date: Jul. 3, 2008

(54) VAPOR HOOD FOR A PAPER MACHINE AND/OR PAPERBOARD MACHINE

(76) Inventors: Ralf Niebe, Weidenberg (DE); Jurgen Horter, Bayreuth (DE); Ronald Hepper, Mistelbach (DE)

Correspondence Address: TAYLOR & AUST, P.C., P.O. Box 560, 142. S Main Street, Avilla, IN, 46710, US

(21) Appl. No.: 11/962,575

(22) Filed: Dec. 21, 2007

Related U.S. Application Data
(63) Continuation of application No. PCT/EP2006/005539, filed on Jun. 9, 2006.

(51) Int. Cl. D21F 5/00; F26B 21/00

(52) U.S. Cl. 34/73; 162/252; 34/114

(57) ABSTRACT

A vapor hood for a paper machine and/or paperboard machine, in particular for the drying section of a paper machine and/or paperboard machine, having a hood housing, wherein an inner housing surface of the hood housing delimits an internal space in which a process area, in particular the drying section, of the paper machine and/or paperboard machine is arranged or can be arranged, wherein on the inner housing surface in at least a sub-region there is arranged at least one condensation sensor for detecting a formation of condensate or an imminent formation of condensate in said sub-region.

### CROSS REFERENCE TO RELATED APPLICATIONS

This is a continuation of PCT application No. PCT/EP2006/005539, entitled “AIR DOME FOR A PAPER OR CARDBOARD MACHINE”, filed Jun. 9, 2006, which is incorporated herein by reference.

### BACKGROUND OF THE INVENTION

1. Field of the Invention

This invention relates to a vapor hood for a paper machine and/or a paperboard machine.

2. Description of the Related Art

Paper machines or paperboard machines have drying sections in which the wet paper web or paperboard web is dried by supplying convective heat or radiant heat usually by way of a cylinder drying system. To remove the large amounts of moisture or high loads of moisture in the air, which can sometimes lie at over 200 g per kg of dried air, efficient air systems for increasing the process reliability and for providing optimum support to the drying process are used. A vapor hood is arranged above the drying section of the paper machine or paperboard machine, thus enclosing said section. The moist air is removed via the vapor hood and an assigned ventilation system and is continually replaced by newly supplied dryer air.

On a vapor hood known from practice and manufactured by the company Wiessner GmbH, Bayreuth, Germany, the hood parts are constructed from aluminum or stainless steel and are bolted to a sturdy, galvanized steel structure with a sealing system and insulated with dimensionally stable mineral wool. Provided on an operator end are lifting gates with a strip window. A dew-point control system and a system for recovering heat from the hood exhaust air can be provided in addition.

In the case of such vapor hoods for paper machines or paperboard machines, an important factor is the energy consumption or primary heat consumption of the drying section of the paper machine, which is lower given a higher moisture content in the exhaust air. However, the higher the moisture content in the vapor hood, the greater the problem of condensate or the condensation of steam on the inside of the housing of the vapor hood, which arises in particular when the temperature on the inner surface of the housing is lower than the dew point or the condensation temperature of the air with the respective moisture load. This condensation problem is very disadvantageous and leads, above all due to drops of water falling onto the paper web or paperboard web, to damage to or tearing of the paper web or paperboard web and hence to significant losses. In addition, the condensation can also result in corrosion on the vapor hood.

The problem of condensation occurs all the more on cold bridges in the region of the wall or inner surface of the vapor hood housing, for example on cross-reinforcement elements on the panels made of metal or on the windows and gates of the vapor hood.

The temperature in the drying section amounts typically to 100° C. to 120° C. On account of the comparatively high temperatures in the internal space of the vapor hood, metals such as aluminum or stainless steel rather than plastics or other heat-insulating materials are currently used at least on the inner surface of the hood housing.

The moisture load of the exhaust air depends on the dew point of the air. For example, given a dew point of 60° C. it is possible to remove a moisture load of 160 g/kg of dry air, and given a dew point of 72° C. it is possible to remove a moisture load of 400 g/kg of dry air. On a modern paper machine it is possible to remove typically 1 million m3/h of waste air via the vapor hood and around 100,000 kg water/h.

It would be a great advantage therefore if the dew point in the vapor hood could be raised without having to take local condensation of condensate and the problems associated therewith into the bargain. It would then be possible to remove a larger amount of moisture with a smaller amount of air.

Known from DE 33 36 998 C2 is a method for the ventilation of paper-machine drying sections with a closed housing, with which hot and moist air is blown out of close-lying side spaces of the vapor hood housing, wherewith the moisture content and the temperature level in the region of the housing's runways is increased and, as the result, the excessive drying of the paper web edges and the heat loss at the ends of the drying cylinders reduced and, therefore, the exhalation of heat from the drying section improved. The air flows through nozzles in downward or obliquely downward direction and out through air ducts in the housing. Hence the air moves in the vicinity of the side walls and the surface temperature of the inner walls of the housing increases, as the result of which the risk of condensation is reduced. The blown-out air can be either air from the inside of the housing or partly air from the housing and partly dry replacement air.

Hence condensation is also prevented, so DE 33 36 998 C2, when the moisture of the waste air from the housing lies in magnitudes of up to 200 g/kg of dry air. In DE 33 36 998 C2 it is explained that condensation with a high moisture load of 200 g/kg of dry air can no longer be prevented by increasingly thick housing wall insulation that this is often owed to high local air moisture levels or lower surface temperatures which arise on heat bridges or leaky areas, in particular on doors and windows of the housing. The elimination of heat bridges and leaky areas would require such an expensive solution as to rule out this option in practice. On DE 33 36 998 C2 provision is made for a heat-insulating wall of the vapor hood housing with an approximately 1 mm thick aluminum sheet on both sides and thermal insulation in the form of 100 mm of mineral wool inside. This covered structure is said to have a heat resistance of 0.833 m2° C./watt, including heat bridges. Insulating glass with 23 mm thick insulating panels and a 15 mm wide air gap are used for the windows.

Known from DE 699 14 920 T2 is a method and an apparatus for drying a coated paper web or paperboard web.

DE 39 25 595 A1 discloses a method and an apparatus for measuring the dew point of gases, in particular the exhaust gas air of a drying hood for a paper machine. In this case the process gas is cooled down to the dew point with the help of a cold gas and then the dew point determined using light which is scattered by the resulting mist. Also described in DE 39 25 595 A. 1 as state of the art for measuring the dew point are so-called “cooling mirror” detectors which optically measure a condensing moisture on a mirror-polished plane, and dew point sensors which work on the basis of the change in capacitance or resistance, and indirect measurements of the dew point through absorption in UV or IR spectra or by microwaves, and a method which uses acoustic emissions.

Disclosed in DD 249 954 A. 1 is a method for reducing the energy consumption on a closed drying system of a paper machine using a dew point control system. Independently of different external air states and a range of webs processed on the paper machine, an experimentally determined plant-specific optimum waste air state with the highest possible dew point is obtained through controlling the amount of carrier air, whereby the temperature of the air fed in is kept constant and the amount of carrier air for transporting the steam is reduced by decreasing the amount of inlet air and outlet air. Using an outlet air moisture sensor, which is arranged in the exhaust air duct between an outlet of the vapor hood and a variable-speed exhaust air fan, the absolute moisture of the hood air is measured, and through comparison with a setpoint value for the exhaust air moisture the exhaust air moisture is regulated by changing the amount of exhaust air to the setpoint value.

What is needed in the art is a vapor hood for a paper machine and/or paperboard machine on which the problem of condensation is at least partly reduced and/or on which the operational dew point can be raised.

### SUMMARY OF THE INVENTION

The present invention provides a vapor hood for a paper machine and/or paperboard machine on which the problem of condensation is at least partly reduced and/or on which the operational dew point can be raised.

The invention in one form is directed to a vapor hood for a drying section of a paper machine and/or a paperboard machine. The vapor hood includes a hood housing and at least one condensation sensor. The hood housing includes an inner housing surface which includes a sub-region, the inner housing surface delimiting an internal space in which the drying section of the paper machine and/or the paperboard machine is arranged. The at least one condensation sensor is arranged on the inner housing surface in at least the sub-region, the at least one condensation sensor being configured for detecting a formation of a condensate or an imminent formation of the condensate in the sub-region.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a schematic representation of the vapor hood of the present invention; and

FIG. 2 is a schematic representation of the control system of the present invention.

Corresponding reference characters indicate corresponding parts throughout the several views. The exemplifications set out herein illustrate embodiment of the invention, and such exemplifications are not to be construed as limiting the scope of the invention in any manner.

### DETAILED DESCRIPTION OF THE INVENTION

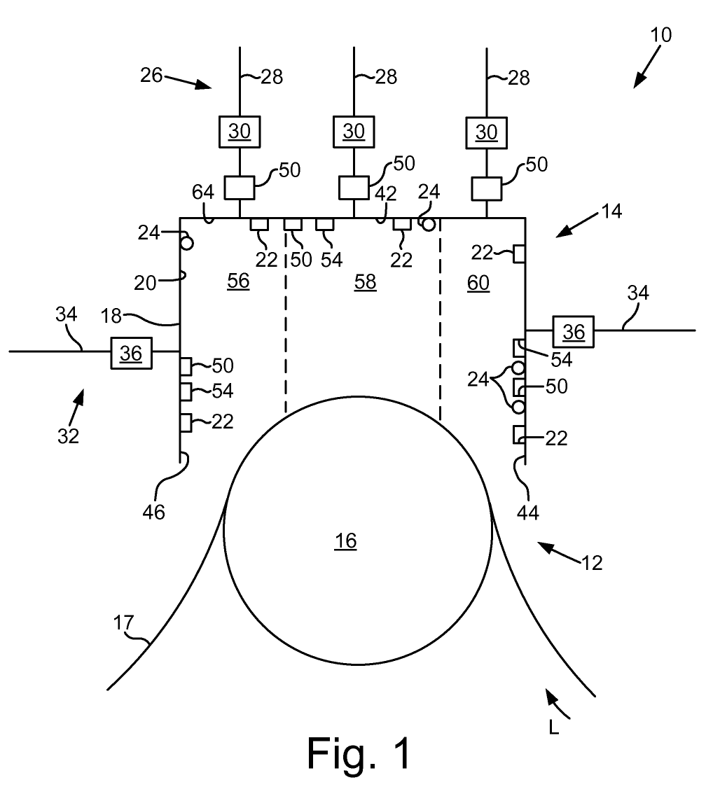

Referring now to the drawings, and more particularly to FIG. 1, there is shown a paper machine 10 and/or a paperboard machine 10 which includes a drying section 12. Drying section 12 includes a vapor hood 14 and a drying cylinder 16 over which a web of fibrous material 17 (such as paper and/or paperboard) travels in a web running direction L. Vapor hood 14 includes a vapor hood housing 18 with an inner surface 20. The present invention provides on the inner face 20 of the vapor hood housing 18 a condensation sensor arrangement and a condensation sensor system with which the inner surface 20 of the vapor hood 14 is monitored for possible or imminent formation of condensation 24. A formation of droplets 24 and hence a possible negative effect on the drying process is thus anticipated or detected by way of sensors (i.e., condensation sensors 22) and incipient condensation 24 can be identified early and be prevented by process engineering ways. As a result, the operation of the vapor hood 14 becomes more reliable and more controlled and the amount of hood exhaust air as well as the amount of process supply air can be optimized. The (theoretical) operational dew point of the vapor hood 14 of the paper machine 10 or paperboard machine 10 can be increased and existing system reserves can be reduced to a safe minimum. This results furthermore in an energy saving in terms of both steam savings for the process air and electricity savings for the supply air fans 36 and exhaust air fans 30. In other words, the degree of efficiency of the moisture removal can be raised and more moisture removed with the same amount of air or the amount of air reduced with removal of the same amount of moisture, thus achieving a lower flow velocity and hence lower loading of the wet paper web 17 by the air current.

An exhaust air discharge system 26 is provided which can include at least one exhaust air duct 28 and at least one exhaust air fan 30. A supply air system is also provided which can include at least one supply air duct 34 and at least one supply air fan 36.

The condensation sensors 22 can be arranged on critical areas or sub-regions of the inner face 20 of the hood 14 where condensation 24 most readily or most probably occurs. In particular the hood roof 42 or the region of the hood housing 18 lying above the drying section 12 of the paper machine 10 and/or the inlet region 44 of the paper machine 10 and/or paperboard machine 10 in the vapor hood 14 and/or the outlet region 46 of the paper machine 10 and/or paperboard machine 10 in the vapor hood 14 are equipped with condensation sensors 22.

The condensation sensors 22 can be arranged in individual sections or arrangements, in particular in the form of grids or other patterns, divided or at a distance from each other.

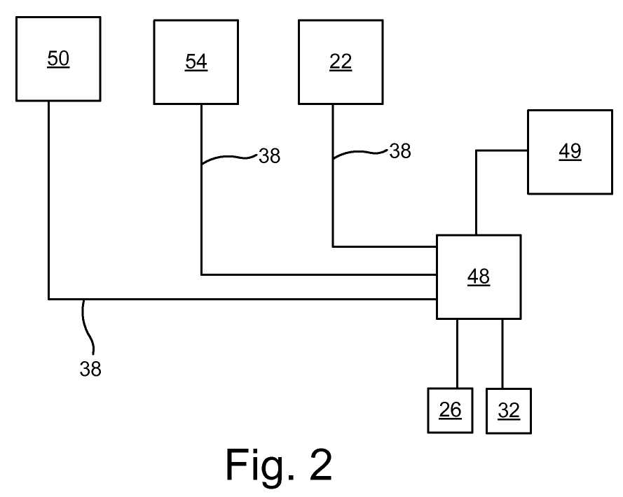

The condensation sensors 22 used can be electrical condensation sensors which detect a change of the electrical capacitance or the electrical resistance between electrical conductors due to a change in the humidity of the air in between or an at least partial replacement of the air in between as medium by a condensed condensate 24 and draw on this as a yardstick for an imminent or already effected formation of condensate 24. In particular, foil sensors made of a substrate with top-printed conductors arranged in pairs can be used as condensation sensors 22. Using an evaluation unit 48 (shown in FIG. 2), the change in an electric voltage or an electric current between or in the printed conductors or the conductance or the capacitance is measured as the sensor signal 38.

The evaluation of the sensor signals 38 (sensor signals are generally numbered as 38 in FIG. 2) of the condensation sensors 22 is scalable or can be performed with different measuring ranges or measuring sensitivities, whereby or as a result of which an assignment to different predefined droplet sizes of the condensate 24, which condenses in particular between the printed conductors, can take place.

Alternatively it is also possible, however, to provide for other condensation sensors 22, for example the dew-point sensors 50 described in DE 39 25 595 A1.

The measurement signals 38 or measurement data of the condensation sensors 22 are continuously monitored or evaluated during operation of the vapor hood 14 individually for each condensation sensor 22 or for groups of condensation sensors 22, in particular in the individual sections, and in particular can be visualized, for example on a display 49 in the form of numerical values and/or a graphic representation, and/or be archived or stored. In addition, the sensor signals 38 or sensor values can also be processed further by way of an evaluation unit 48, in particular a computer, and the evaluations made available to a higher-level process control system 52 for example through an interface, in particular a bus interface.

Critical states in which predefined limit values for the droplet size or humidity on an area of one or more condensation sensors 22 on the inner face 20 of the housing 18 are exceeded (bad point detection) are signaled as a pre-alarm and/or main alarm.

To realize an optimization function, a known dew-point control system is cascaded with a dew-point sensor 50 in the total exhaust air or in the exhaust air duct 28 of the vapor hood 14 through a setpoint value shift, the dew-point control system including dew-point sensor 50 and evaluation unit 48. This means that the setpoint value of the dew-point control corresponding to the desired dew point is continuously increased as control variable (=variable setpoint value) of the dew-point control by reducing the amounts of air as setpoint variables until the bad point detection system indicates that the related limit value for a still permissible droplet size is exceeded or the condensation sensor or sensors 22 detect the first small droplets 24. The control system is calibrated to this control point or setpoint value (constant control variable), whereby preferably small safety reserves can be set. Hence the dew point is operated near the bad point detection or the limit values of the condensation sensors 22. If, during operation, the condensation 24 increases on the condensation sensors 22 or the droplet size or the formation of droplets 24 or the number of droplets 24 increases, then the control variable of the dew point control system will be reduced again until a non-critical operating state is restored, meaning the condensation 24 detected by the condensation sensors 22 drops again below the maximum permissible level.

In addition it is possible, in those sub-regions (which can be sub-regions 42, 44, and/or 46) where condensation sensors 22 are arranged, to provide also temperature sensors 54 in order to measure the local temperature and, if required, to derive information about thermodynamic variables such as the dew point from the signals 38 or data of the temperature sensors 54 and the condensation sensors 22. With said information it is possible for the sensor signals 38 of the condensation sensors 22 to be subjected to temperature compensation or scaling using the temperature measured values or measurement signals 38. As shown in FIG. 2, evaluation unit 48 can receive signals 38 from condensation sensors 22, dew-point sensors 50, and/or temperature sensors 54, and output from evaluation unit 48 (based at least in part on signals 38) can then be used to control exhaust air discharge system 26 and/or supply air system 32; evaluation unit 48 can itself be used to control systems 26 and/or 32.

In another advantageous embodiment the vapor hood 14 is divided into individual zones, for example three zones 56, 58, 60 in the direction L of the paper 17 or paperboard 17 transport, and the described condensation monitoring by way of the condensation sensors 22 and preferably also the control of the dew point dependent on said condensation monitoring are performed separately for each of the zones 56, 68, 60. As a result, the degree of efficiency can be selectively optimized for each of these zones dependent on the respective moisture load in the respective zone. The vertically extending broken lines in FIG. 1, for example, delineate three zones 56, 58, 60.

Similarly it is also possible for the distribution of air current in the internal space 64 or zones 56, 58, 60 of the vapor hood 14 to be set through selective control of the amounts of air in individual air supply ducts 34 and/or air extraction ducts 28 dependent on the condensation monitoring.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A vapor hood for a drying section of at least one of a paper machine and a paperboard machine, said vapor hood comprising:
a hood housing including an inner housing surface which includes a sub-region, said inner housing surface delimiting an internal space in which the drying section of at least one of the paper machine and the paperboard machine is arranged; and
at least one condensation sensor arranged on said inner housing surface in at least said sub-region, at least one said condensation sensor configured for detecting one of a formation of a condensate and an imminent formation of said condensate in said sub-region.

2. The vapor hood according to claim 1, further including a plurality of said condensation sensors, said inner housing surface including a plurality of said sub-regions, at least one of said plurality of condensation sensors being arranged respectively in said plurality of sub-regions.

3. The vapor hood according to claim 1, further including a plurality of said condensation sensors, said inner housing surface including a plurality of said sub-regions, said plurality of condensation sensors being arranged in said plurality of sub-regions where condensation one of most readily and most probably occurs.

4. The vapor hood according to claim 1, further including a plurality of said condensation sensors, said inner housing surface including a plurality of said sub-regions, at least one of the paper machine and the paperboard machine including an inlet region in the vapor hood and an outlet region in the vapor hood, said plurality of sub-regions including a first sub-region, a second sub-region, and a third sub-region, said first sub-region being one of a hood roof and a sub-region lying above the drying section of at least one of the paper machine and the paperboard machine, said second sub-region lying in the vapor hood at said inlet region, and said third sub-region lying in the vapor hood at said outlet region, at least one of said plurality of condensation sensors being arranged respectively in at least one of said first sub-region, said second sub-region, and said third sub-region.

5. The vapor hood according to claim 1, further including a plurality of said condensation sensors which are arranged in at least said sub-region, said plurality of condensation sensors being set apart from each other.

6. The vapor hood according to claim 1, wherein said formation of said condensate includes an already formed condensate, at least one said condensation sensor including one of a plurality of printed conductors and a plurality of conductor sections one of set apart and insulated from each other, a change of one of an electrical resistance and an electrical capacitance between one of said plurality of printed conductors and said plurality of conductor sections one of being used and configured for being used as a yardstick for one of said already formed condensate and said imminent formation of said condensate.

7. The vapor hood according to claim 1, further including a plurality of said condensation sensors and an evaluation unit configured for evaluating a plurality of measurement signals or a measurement data of at least one said condensation sensor or each of said plurality of condensation sensors of at least said sub-region of said inner housing surface or from a plurality of groups of interconnected ones of said plurality of condensation sensors.

8. The vapor hood according to claim 7, wherein a) a measuring range or a measuring sensitivity of said evaluation unit or b) said plurality of measurement signals or said measurement data of said plurality of condensation sensors is scalable or individually selectable, as a result of which an assignment to different predefined droplet sizes of said condensate or different humidities is effected.

9. The vapor hood according to claim 7, wherein said evaluation unit at least one of continuously evaluates said plurality of measurement signals or said measurement data of respective ones of said plurality of condensation sensors, visualizes said plurality of measurement signals or said measurement data, archives said plurality of measurement signals or said measuring data, and is configured for making said plurality of measurement signals or said measurement data available to a higher-level process control system.

10. The vapor hood according to claim 9, wherein said evaluation unit visualizes said plurality of measurement signals or said measurement data on a display as a plurality of numerical values or a graphic representation.

11. The vapor hood according to claim 7, wherein said evaluation unit is configured for signaling a plurality of critical states in which a plurality of predefined limit values of said plurality of measurement signals or said measurement data are reached or a plurality of predefined limit values for droplet size or humidity on an area of at least one said condensation sensor on said inner housing surface are exceeded.

12. The vapor hood according to claim 11, wherein said evaluation unit is configured for signaling said plurality of critical states as at least one of a pre-alarm and a main alarm.

13. The vapor hood according to claim 7, further including an exhaust air discharge system of the vapor hood and a dew-point control system including at least one dew-point sensor in said exhaust air discharge system of the vapor hood, said dew-point control system being configured for continuously increasing a dew point as a control variable of said dew-point control system by reducing at least one of an amount of supply air and an amount of exhaust air as at least one setpoint variable such that a maximum value of said control variable, at which an inadmissible formation of said condensate is still not detected by said evaluation unit using said plurality of condensation sensors, or a value for said control variable lying by a predefined safety margin below said maximum value of said control variable is set as a setpoint value for said dew-point control system.

14. The vapor hood according to claim 13, wherein, if an inadmissible formation of said condensate is detected by said evaluation unit using said plurality of condensation sensors, said dew-point control system is configured for continuously reducing said dew point as said control variable of said dew-point control system by increasing at least one of said amount of supply air and said amount of exhaust air as at least one said setpoint variable until a new said maximum value of said control variable, at which said inadmissible formation of said condensate is no longer detected by said evaluation unit using said plurality of condensation sensors, is reached and said new maximum value of said control variable or said value for said control variable lying by said predefined safety margin below said maximum value of said control variable value is drawn on as said setpoint value for said dew-point control system.

15. The vapor hood according to claim 7, further including a temperature sensor arranged, in addition to at least one said condensation sensor, in at least said sub-region of said inner housing surface, said temperature sensor configured for detecting temperature in at least said sub-region.

16. The vapor hood according to claim 15, wherein said evaluation unit is configured for using a plurality of temperature measurement values or temperature measurement signals to subject said plurality of measurement signals or said measurement data of said plurality of condensation sensors, or scaling of said plurality of measurement signals or said measurement data of said plurality of condensation sensors, to a temperature compensation.

17. The vapor hood according to claim 1, further including a plurality of said condensation sensors, the vapor hood defining a plurality of individual zones, said plurality of condensation sensors configured for monitoring or detecting said formation of said condensate or said imminent formation of said condensate in said plurality of individual zones separately for each of said plurality of individual zones.

18. The vapor hood according to claim 17, further including a dew-point control system configured for monitoring or detecting said formation of said condensate or said imminent formation of said condensate in said plurality of individual zones separately for each of said plurality of individual zones.

19. The vapor hood according to claim 17, wherein said plurality of individual zones includes at least three zones in a direction of a paper transport or a paperboard transport.

20. The vapor hood according to claim 17, further comprising a plurality of air supply ducts and a plurality of air extraction ducts, at least one of said plurality of air supply ducts and said plurality of air extraction ducts being configured for selectively controlling an amount of air therein dependent on said monitoring of said formation of said condensate or said imminent formation of said condensate in order to set a distribution of air current in said internal space or at least one of said plurality of individual zones.
